(19) United States
(12) Patent Application Publication
(10) Pub. No.: US 2015/0310406 A1
(43) Pub. Date: Oct. 29, 2015

(54) Systems and Methods for Automated Invoice Processing

(71) Applicant: BluTrend, LLC, Atlanta, GA (US)

(72) Inventors: Michael H. Anderson, Atlanta, GA (US); Brian N. King, Atlanta, GA (US); Raymond Hasty, Woodstock, GA (US)

(73) Assignee: BluTrend, LLC, Atlanta, GA (US)

(21) Appl. No.: 14/261,508

(22) Filed: Apr. 25, 2014

(51) Int. Cl. G06Q 20/14

(52) U.S. Cl. CPC G06Q 20/14

(57) ABSTRACT

Certain implementations of the disclosed technology may include systems, methods, and computer-readable media for automated invoice processing. A computer-implemented method is provided for querying, on behalf of a payer, at least one payee database to request and retrieve invoice data associated with at least one invoice account payable by the payer. The method includes retrieving, prior to physical mailing or payer receipt of the at least one invoice, at least a portion of the invoice data; extracting at least a portion of the invoice data; consolidating the extracted invoice data into a standardized data format; auditing one or more of the extracted and consolidated invoice data; associating, based at least in part on the auditing, a payer general ledger (GL) number with one or more of the retrieved, extracted, and consolidated invoice data; and outputting at least a portion of the consolidated data and the associated GL number.

### BACKGROUND

Many companies utilize modern computer-implemented accounting systems to streamline billing and accounts receivables. These systems continue to benefit from the improvements in computer technology and Internet connectivity. Prior to the advent of computers and the Internet, most bills were printed on paper and physically mailed to customers. The customers, in turn, would typically pay the bill via cash, check or credit card. With modern systems, however, a billing entity can utilize an automated system to generate invoices, notify customers of bills, receive payments, etc.

Such computer-implemented systems have provided significant efficiencies for the billing entity (payee), but due to lack of a billing standardization, the customer (payer) typically must interface in a unique way with each separate billing entity in order to pay bills. Online banking and associated bill payment systems have recently been utilized by banking institutions to make the bill payment process more convenient for the payer. For example, a customer may sign up for automated billing to receive and pay bills via a convenient web accessible portal associated with a bank account. However, certain companies, such as those that are involved in property management, have unique accounting challenges that often involve multiple vendor accounts associated with multiple units.

### SUMMARY

Some or all of the above needs may be addressed by certain implementations of the disclosed technology. Certain implementations of the technology disclosed herein may include systems, methods, and computer-readable media automated invoice processing. In particular, systems, methods, and computer-readable media are disclosed for electronically retrieving, auditing, consolidating, and uploading invoices.

According to an example implementation of the disclosed technology, a computer-implemented method is provided for querying, on behalf of a payer, at least one payee database to request and retrieve invoice data associated with at least one invoice account payable by the payer. The method includes retrieving, prior to physical mailing or payer receipt of the at least one invoice, at least a portion of the invoice data; extracting at least a portion of the invoice data; consolidating the extracted invoice data into a standardized data format; auditing one or more of the extracted and consolidated invoice data; associating, based at least in part on the auditing, a payer general ledger (GL) number with one or more of the retrieved, extracted and consolidated invoice data; and outputting at least a portion of the consolidated data and the associated GL number.

Embodiments of the disclosed technology include a system having a least one memory for storing data and computer-executable instructions; and at least one processor configured to access the at least one memory and further configured to execute the computer-executable instructions to: query, on behalf of a payer, at least one payee database to request and retrieve invoice data associated with at least one invoice account payable by the payer; retrieve, prior to physical mailing or payer receipt of the at least one invoice, at least a portion of the invoice data; extract at least a portion of the invoice data; consolidate the extracted invoice data into a standardized data format; audit one or more of the extracted and consolidated invoice data; associate, based at least in part on the auditing, a payer general ledger (GL) number with one or more of the retrieved, extracted and consolidated invoice data; and output at least a portion of the consolidated data and the associated GL number.

According to another example implementation, a computer-readable medium is provided for storing instructions, that when executed by a user device having one or more processors, cause the computer device to perform a method. The method includes querying, on behalf of a payer, at least one payee database to request and retrieve invoice data associated with at least one invoice account payable by the payer. The method includes retrieving, prior to physical mailing or payer receipt of the at least one invoice, at least a portion of the invoice data; extracting at least a portion of the invoice data; consolidating the extracted invoice data into a standardized data format; auditing one or more of the extracted and consolidated invoice data; associating, based at least in part on the auditing, a payer general ledger (GL) number with one or more of the retrieved, extracted and consolidated invoice data; and outputting at least a portion of the consolidated data and the associated GL number.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative invoice consolidation process 100, according to an example implementation of the disclosed technology.

FIG. 2 is an illustrative diagram of system 200 for retrieving and processing invoice information.

FIG. 3 is a block diagram of an illustrative computing system 300, according to an example implementation of the disclosed technology.

FIG. 4 is a flow diagram of a method according to an example implementation.

FIG. 5 is a flow diagram of a method according to an example implementation.

FIG. 6 is a flow diagram of a method according to an example implementation.

FIG. 7 is a flow diagram of another method 700 according to an example implementation.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth herein.

Various systems and methods disclosed herein may be utilized for automated bill retrieval and consolidation, and will now be described with reference to the accompanying figures.

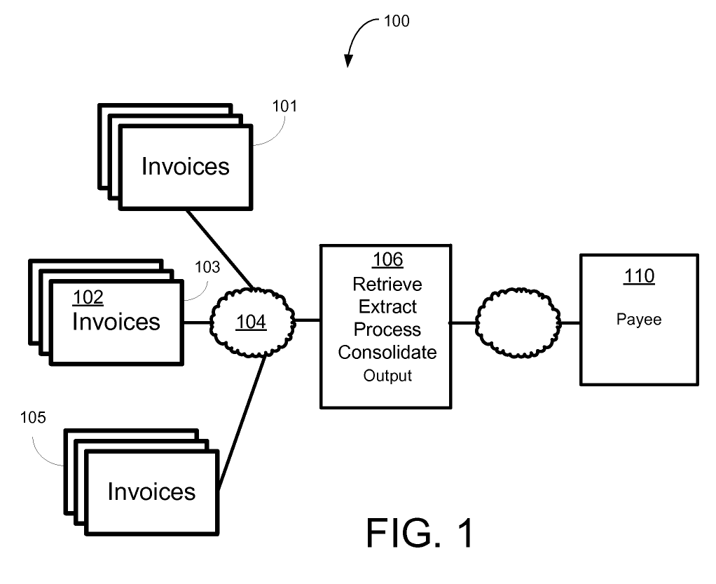

FIG. 1 shows a block diagram of an example invoice consolidation process 100. In one example implementation of the disclosed technology, one or more vendors 101 103 105 may generate bills or invoices 102 for their customers. In certain embodiments, electronic versions of the invoices 102 for an account may be made available for online inspection or download by a payer or other entity associated with the account, or by a party who possesses the proper login information or credentials. In certain example implementations, the invoices 102 may be available via a network connection 104. For example, the invoices 102 may be exposed for inspection and/or download via the vendor's website, or via other web services such as FTP and the like.

Systems and methods of the disclosed technology may utilize various processes 106, for example, to retrieve, extract, process, consolidate, and/or output the invoice information for use by a payee 110. For example, outstanding bills or invoices 102 associated with multiple accounts and multiple vendors may be consolidated and identified by the payer's general ledger (GL) numbers. In certain example implementations, the consolidated invoice information may be sent to the payee 110, or exposed for download by the payee 110 via an internet connection.

According to an example implementation of the disclosed technology, the invoices 102 may be generated by the vendors 101 103 105 and made available in electronic format prior to a printing of a hard copy of the invoices 102 for mailing to the various payees. Embodiments of the disclosed technology may take advantage of the electronically available invoice information to provide the payee 110 with the invoice information prior to a hard copy of the bill being mailed to the payer.

Certain example implementations of the disclosed technology may retrieve invoices 102 or data from the invoices 102 prior to a payer receipt of the invoice 102. For example, periods in which the invoices 102 (and/or associated data) may be retrieved from a vendor include one of more of the following: (1) before physical mailing; (2) before e-bill notification; (3) after physical mailing but before payer receipt of that mailing; (4) after e-bill notification but still independent of that notification; and/or (5) within about 24 hours of the vendor publishing the invoice. Certain example embodiments may retrieve invoice information from a vendor and provide it to a customer in a timely advantageous manner. Certain example implementations of the disclosed technology may utilize a scheduling of a batch framework job to run more than once a day to further detect and retrieve newly available invoice information.

According to various example implementations of the disclosed technology, the invoices 102 may be generated and/or made available in various formats, including but not limited to PDF documents, text documents, images, HTML pages, etc. One aspect of the disclosed technology includes appropriate processing of the various invoice formats to extract the invoice information.

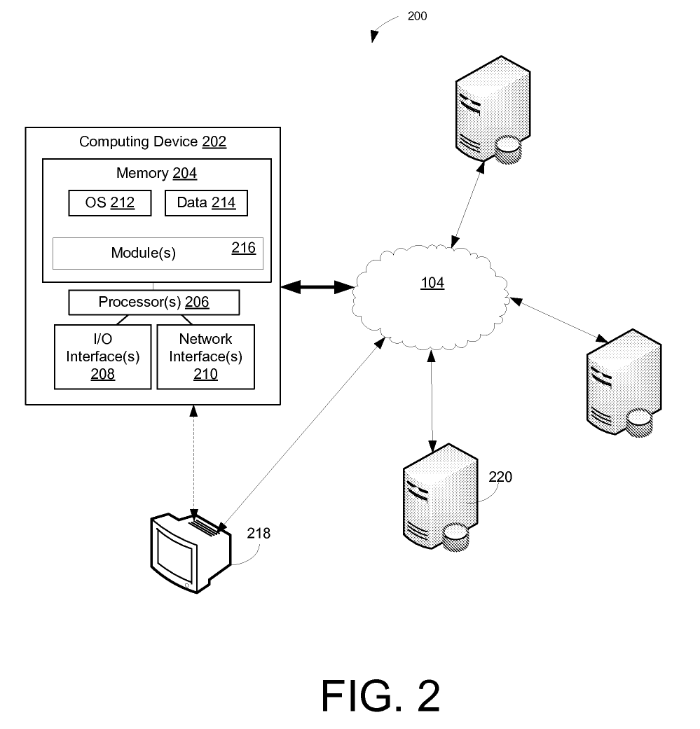

FIG. 2 is an illustrative diagram of a system 200 for retrieving and processing invoice information. Certain example embodiments of the disclosed technology include a computing device 202 for interfacing with one or more vendor servers 220, for example, via a network connection 104 (such as via an Internet connection, for example). Certain example implementations may further include the capability of interfacing with a payer system 218 directly or via the network connection 104.

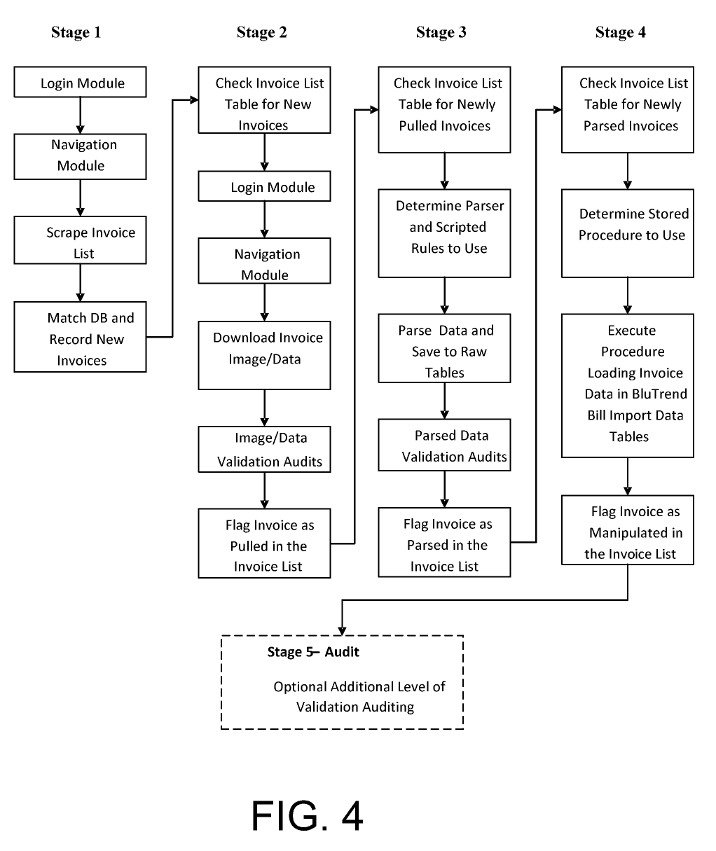

In accordance with an example implementation of the disclosed technology, the computing device 202 may include a memory 204, one or more processors 206, an input/output interface 208, and one or more network interfaces 210 for communication among the vendor servers 220 and the payer system 218. In certain embodiments, the computing device 202 includes an operating system 212, data 214, and one or more modules 216 with computer readable instructions that, when executed by the one or more processors 206, cause the computing device 202 to execute the various processes, as will be explained in more detail with regard to FIGS. 4-7.

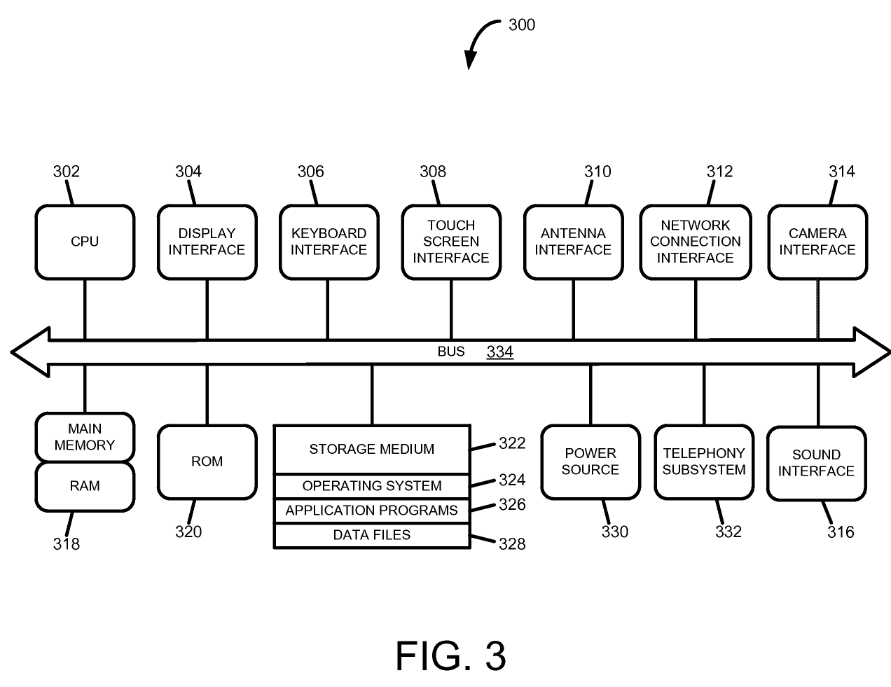

FIG. 3 is a block diagram of an illustrative computing device 300, according to an example implementation of the disclosed technology. The computing device 300 may be embodied as the computing device 202, as shown in FIG. 2. In certain example implementations, the computing device 300 may represent a vendor server 220 and/or a payer system 218, as shown in FIG. 2.

The computing device 300 of FIG. 3 includes a central processing unit (CPU) 302, where computer instructions are processed; a display interface 304 that acts as a communication interface and provides functions for rendering video, graphics, images, and texts on the display. In certain example implementations of the disclosed technology, the display interface 304 may be directly connected to a local display, such as a touch-screen display associated with a mobile computing device. In another example implementation, the display interface 304 may be configured for providing data, images, and other information for an external/remote display that is not necessarily physically connected to the computing device. For example, a desktop monitor may be utilized for mirroring graphics and other information that is presented on the computing device 300. In certain example implementations, the display interface 304 may wirelessly communicate, for example, via a Wi-Fi channel or other available network connection interface 312 to the external/remote display.

In an example implementation, the network connection interface 312 may be configured as a communication interface, for example, to provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device 300 may include a keyboard interface 306 that provides a communication interface to a keyboard. In one example implementation, the computing device 300 may include a pointing device or touch screen interface 308. According to certain example implementations of the disclosed technology, the pointing device or touch screen interface 308 may provide a communication interface to various devices such as a pointing device, a touch screen, a depth camera, etc. which may or may not be associated with a display.

The computing device 300 may be configured to use an input device via one or more of input/output interfaces (for example, the keyboard interface 306, the display interface 304, the display interface 308, network connection interface 312, camera interface 314, sound interface 316, etc.,) to allow a user to capture information into the computing device 300. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor such as an accelerometer or gyroscope, a smartcard, and the like. Additionally, the input device may be integrated with the computing device 300 or may be a separate device.

Example implementations of the computing device 300 may include an antenna interface 310 that provides a communication interface to an antenna; a network connection interface 312 that provides a communication interface to a network. In certain implementations, a camera interface 314 is provided for capturing digital images, for example, from a camera. In certain implementations, a sound interface 316 is provided as a communication interface for converting sound into electrical signals using a microphone and for converting electrical signals into sound using a speaker. According to example implementations, a random access memory (RAM) 318 is provided, where computer instructions and data may be stored in a volatile memory device for processing by the CPU 302.

According to an example implementation, the computing device 300 includes a read-only memory (ROM) 320 where invariant low-level system code or data for basic system functions such as basic input and output (I/O), startup, or reception of keystrokes from a keyboard are stored in a non-volatile memory device. According to an example implementation, the computing device 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, an invoice extraction module, etc.) and data files 328 are stored. According to an example implementation, the computing device 300 includes a power source 330 that provides an appropriate alternating current (AC) or direct current (DC) to power components. According to an example implementation, the computing device 300 may include and a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data may be stored in the RAM 318, where the data may be accessed by the computer CPU 302 during execution. In one example configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

### Batch Framework Overview

Certain example embodiments of the disclosed technology utilize a batch framework (BF), for example, as a job workflow system to group multiple tasks within a job, and then schedule that job to run at various times. Tasks, for example, can be anything from custom executables to execution of stored procedures. Tasks can be job specific or generic enough to be used across multiple jobs. In certain example implementations, BF jobs may be scheduled, run on demand and/or, depending on the task's parameters, a job can often be customizable to further refine the functionality to the needs at hand. Certain example implementations of the disclosed technology utilize Batch Framework for all bill data collection processing.

### Bill Data Collection Overview

According to an example implementation of the disclosed technology, bill data collection may include multiple stages. In certain example implementations, the bill data collection may include a login module. The stages associated with the bill data collection may become tasks in a Batch Framework job, for example, to pull the billing data for a particular entity. In one example implementation, the Bill Data Collection process may be utilized to bring in bill data from a source and transform it into appropriate framework for a standardized bill data import model.

According to an example implementation of the disclosed technology, a portion of the code used by the Bill Data Collection process may be contained within common method libraries. For example, each vendor may have custom code wrappers for each of the stages that deal with the nuances encountered on each site. These wrappers may utilize the various common methods as well as any custom methods to achieve the desired result. As used herein, a group of Bill Data Collection Stages for a vendor may be collectively known as a Bill Importer.

FIG. 4 is an example flow diagram of a standard bill collection cycle with the various Stages and associated steps. Certain example embodiments of the disclosed technology may utilize each stage and step, while other embodiments may omit certain steps as needed.

### Stage 1—Invoice List

According to an example implementation of the disclosed technology, the invoice list stage may be viewed as a web page scraper. For example, this stage may include the login process and navigation through pages that might be required to accumulate the list of invoices available for download. In one example implementation, the invoice list may be saved to the database and may be used to control subsequent processing.

### Stage 2—Invoice Download

According to an example implementation of the disclosed technology, the invoice download stage may also be viewed as part of a web page scraper. In an example implementation, invoices that need to be pulled may be identified in Stage 1. For example, the Invoice Download stage may include logging on and navigating thru whatever pages might be identified in Stage 1 to access the identified invoice image/data that is identified in Stage 1 as not yet been pulled. In certain example implementations, the Invoice Download stage may then proceed to capture the identified image and/or download the identified data.

### Stage 3—Invoice Parser

In accordance with example implementations, invoices may be presented in certain formats and processed accordingly. For example, invoices may be in the form of various PDF formats, images, Excel files, comma-separated values (CSV), delimited text, XML, and HTML data. Based on scripted rules, and according to an example embodiment, the parser may extract the desired information, and this information may be stored in a database with structures to match the data as it is grouped on the bills. In certain example implementations, the data may be stored in a raw format.

### Stage 4—Manipulation

According to an example implementation of the disclosed technology, manipulation of the data may be performed within the database using a Stored Procedure. For example, the procedure may convert raw data to a table such as a Billing Data Import Model. In certain example implementations, other key fields may be incorporated for assisting additional Data Import runs.

### Stage 5—Audit

In certain embodiments, the Audit Stage may be integrated within Stage 3 and Stage 4, for example, to provide custom validation audits being performed specific to the data being obtained. Therefore, in certain example implementations, the Audit Stage may be optional. In other example implementations, the Audit stage may perform the various checks to verify the integrity and content of the data.

According to certain example implementations of the disclosed technology, the various stages presented above may be viewed as a process with a number of stages. For example, the process may identify URLs needed to login and navigate to the various pages to scrape. In certain example implementations, the various URLs may be updated and stored in the database as needed for future bill cycles. The process may include integrating the retrieval of the Invoice List into the test platform, and the test platform may be extended to download the invoice in the available format. In certain embodiments, the process may include adding a Batch Framework job at the first two tasks (Stage 1 and 2), for example, to enable downloading invoices so that they will be available as subsequent tasks complete development. In certain example implementations, the process may extend the test platform to include parsing the invoice. In certain example implementations, the parsing task may be added to the Batch Framework job. In accordance with an example implementation, the process may include creating a manipulation step or module. In certain example implementations, the process may include adding the manipulation task to the Batch Framework job. In certain example implementations, the process can include creating an audit step for any custom audits that are needed, and the audit task may be added to the Batch Framework job.

### Bill Data Collection Details

As discussed above with reference to FIG. 4, the various stages may include additional details, requirements, development methodology, and/or processing methodology. These additional details will now be described below.

### Stage 1—Invoice List

In accordance with an example implementation, an account setup on a vendor's web site may be required with access to as many variations as might exist so that invoices and associated data may be retrieved. In certain embodiments, variations can include either single account invoices or summary account invoices. In other embodiments, variations can include different formats available for inspection and/or download. In certain example implementations, a User ID and Password may be required to access accounts saved in vendor's database. In accordance with an example implementation, basic URLs may need to be known to navigate the vendor's website and access the necessary data. In an example implementation, a tool such as HTTP Analyzer may be utilized to gather information about a vendor's website so that it may be determined how the web site is organized, how it functions, etc.

Certain example implementations may include a development methodology for the various stages. For example, certain embodiments may utilize a web browser and the HTTP Analyzer tool in Stage 1 to record a session that logs on to the utility's web site and navigates through all the pages required to access the Invoice List. Certain example implementations may update the Login Module with any special requirements, for example, to support features on the vendor's website. In certain example implementations, using the Login Module and the URL information as parameters, the system may submit the HTTP requests required to accomplish a log on. In an example implementation, an Invoice List function may be created for the vendor website so that it can accept all required input and submit the HTTP requests needed for the Invoice Listing screen. In certain example implementations, a test platform may be created and/or used to verify the results of the Invoice List function, for example. Certain example implementations of the disclosed technology may create a Batch Framework executable that can invoke the Invoice List function and record the results on the database.

According to an example implementation of the disclosed technology, each Invoice List entry may have some sort of unique key. For example, an invoice number may be utilized where available. If no unique ID is available from the vendor, a combination of or one or more of an invoice date, due date and invoice amount may be used to generate an ID. In certain embodiments, the invoice data may be downloaded, parses and then analyzed for key data to determine uniqueness.

In certain example implements, a test platform may be built as a permanent entity. For example, if there are changes or problems with a site, the test platform may be utilized to develop appropriate fixes, repairs, workarounds, etc.

In accordance with an example implementation, the stages may include a processing methodology. The following may be representative of the most common sequence of events. For example, a batch framework job may be created containing Stage 1. In certain example implementations, the batch framework job may include all Stages with Stage 1 being the first task within the job. In certain example implementations, the batch framework job may provide the task with the parameters that enable the processing of the particular stage. For example, a common parameter may be a customer identifier. According to an example implementation of the disclosed technology, a login module may be called, for example, to accesses the vendor's database and provide stored login credentials and the site's URL)

In accordance with an example implementation, and upon successful login, a navigation module may be called to accesses the vendor's database, for example, to retrieve the URL(s) as needed to navigate to the invoice-listing page. Some sites may have these lists by account so it may be necessary to call this Navigation Module multiple times (once for each account). In some cases, each recall may use the same URL(s) pulled so database interaction may not be needed on the subsequent calls. Once the invoice-listing page is accessed, the system may then scrape or copy the list of invoices from the vendor's page. According to certain example implementations, the system may compare the list of invoices with what is in the database and write those that are new to the invoice list table in the database. If the utility has multiple accounts then the process may be repeated until all accounts have been processed.

### Stage 2—Invoice Download

As in Stage 1, and in accordance with an example implementation, an account setup on a vendor's web site may be required with access to as many variations as might exist so that invoices and associated data may be located and downloaded.

In certain example implementations, a development methodology for this stage may include using a web browser and the HTTP Analyzer tool, for example, to record a session that logs on to the utility's web site and navigates through all the pages required to download the invoice image/data. The methodology may include a download function to download an invoice based on its source type (PDF, image, CSV, etc.). In an example implementation, the download function may be configured to accept all required input and submit the HTTP requests needed to download the invoice image/data. In certain example implementations, the same or similar login module as is used to obtain the invoice list may be utilized. According to an example implementation of the disclosed technology, the download function may be added to the test platform. Certain example implementations of the disclosed technology may create a batch framework executable that can invoke the download function and store the image in the appropriate location.

According to certain example embodiments, the following processing methodology may be utilized at this stage. It should be recognized that while there are variations, this listing may be representative of a common sequence of events. For example, a batch framework job may be created containing this stage (task), but the most frequent use of this task is in a job where it follows Stage 1 and has the other Stages following it. For example, the batch framework can be setup to run as the first task in a job where the vendor has timing issues on their website and will publish invoices on the invoice list before the actual image/data is available. In certain example implementations, the batch framework job may provide the task with the parameters that will be used to process the Stage. A common parameter, for example, is a customer identifier, but for the scheduled jobs, the parameter may be left to default to all.

In accordance with an example implementation, the first action within the download function may be to query the vendor's database to determine what invoices need to be downloaded. For example, the system may examine the invoice list table to see which ones have not yet been flagged as being pulled, and if there are no flagged invoices, this Stage may end.

In certain example implementations, the login module may be called, for example, to access a database for login credentials and site's login URL. Upon successful login, the navigation module may be called again, for example, to access the database to get the URL(s) needed to navigate to the invoice image/data. Some sites build the final URL to access the invoice image/data dynamically and in those cases, the navigation module may navigate to the point where the URL can be predetermined and the URL may then be handed off to the download code that may have custom scripting to continue. In accordance with an example implementation, this step may be called for each invoice that has not yet been pulled but in most cases, each recall uses the same URL(s) so database interaction is not needed on the subsequent calls.

In accordance with an example implementation, the processing methodology can include downloading image/data. For example, when downloading an image, this step may be utilized to store the image in an appropriate folder based on the vendor, customer and date. When downloading data, this step may store it in a holding folder for further processing.

In accordance with an example implementation, the processing methodology can include validation. For example, the two most often performed validations are (1) a checksum validation to make sure the invoice is not a potential duplicate with an invoice previously downloaded, and (2) a check to verify that images are valid for the file type, or that data files are well formed. Certain embodiments may log any issues that are found.

In accordance with an example implementation, the processing methodology can include updating the invoice list to reflect that the invoice has been pulled. If multiple accounts need to be pulled, part of all of this process may be repeated until each item in the invoice list has been processed.

### Stage 3—Invoice Parser

Example embodiments of the disclosed technology may utilize various functions and/or open source libraries that can be used to manipulate PDF files. According to an example implementation of the disclosed technology, certain library function are modified to provide additional functionality. For instance, one added functionality allows access of PDF text by specifying a particular dimensional region (window) on the page. For example, the system can specify and parse text in a PDF document within a region 2 inches from top, 6 inches from bottom, 3 inches from left margin, and 1 inch from right margin.

According to certain example embodiments, the following development methodology may be utilized at this stage. It should be recognized that while there are variations, this listing may be representative of a common sequence of events. In one example implementation, the invoice's source file (image for OCR, PDF text, delimited text, XML, HTML, etc.) may be evaluated to identify the approach that will be used to process the file. In an example implementation, the evaluation may determine what information should be collected and how best to access that information.

In accordance with an example implementation, the development methodology can include creating an invoice parse function, for example, that uses the appropriate tool to parse the invoice source file. Certain example implementations of this function may be scripted to pull the individual data elements specific to the vendor's bill format and source type. These data elements may be grouped into tables that can eventually be uploaded to the raw tables on the database. In certain example implementations, these custom functions may be identified by naming conventions and may identify the vendor and possible bill format.

In accordance with an example implementation, the development methodology can include create the raw tables that will store the information parsed from the vendor's invoice. This structure generally follows the invoice layout groupings, for instance, reads in one table, detail line items in another and general invoice information in yet another. Certain example implementations of the disclosed technology may add the above invoice parse function to the test platform and verify results for each of the raw data tables. During the validation of the data in the above step, data may identify by data audits that might be needed, and such data may be added to the function for logging.

In accordance with an example implementation, the development methodology can include creating a batch framework task to invoke the above functionality and copy the results into the raw data tables on the database.

According to certain example embodiments, the following processing methodology may be utilized at this stage. It should be recognized that while there are variations, this listing may be representative of a common sequence of events. For example, a batch framework job may be created containing this stage (task). While it is possible to run this as its own job, a specific job may include the invoice download stage before it. In certain example implementations, the batch framework job may provide the task with the parameters that will be used to process the stage. The most common parameter is a customer identifier but for the scheduled jobs, it is generally left to default to all.

In accordance with an example implementation, the first action within the invoice parse function may be to query a database to determine what invoices need to be parsed. For example, the invoice parse function may look in the invoice list table to see which ones have not yet been flagged as being parsed. If there are no flagged invoices in the invoice list table, this stage may end.

In accordance with an example implementation, the invoice parse function may support multiple variations of the vendor's bill. In certain example implementations, the invoice parse function may determine what bill variation is being processed. Either this can be determined directly from the invoice list table or it might be identified from additional lookup tables. In accordance with an example implementation, the invoice parse function may call the appropriate tool, for example, to parse the invoice source file. During the parsing, the invoice parsing function may pull the information specified during development. In certain example implementations, the information may be and then saved within appropriate raw tables. If errors occur during parsing, they may be logged in a database log table.

Since vendors generally have their own unique raw table structures, the validation may also be unique. However, even though the data points vary, there are still some generic auditing points that may be covered at this stage. For example, in one example implementation, a check may be made to see if the invoice is a duplicate with any other invoices. In an example implementation, a check may be made to make sure amounts at various levels add up (for example, a sum of line-item details equal bill total, etc.). In certain example implementations, checks may be made to make sure required elements exist, such as account numbers, service locations, and dates, where appropriate. Certain example implementations of the disclosed technology may log any issues found.

In an example implementation, the invoice list may be updated to reflect that the Invoice has been parsed. If multiple accounts need to be parsed, the process described may be repeated.

### Stage 4—Manipulation

Certain example implementations may include a development methodology for this stage. In an example implementation, a stored procedure may be created to apply rules to map the raw data into a final bill import data structure. This procedure, in one embodiment, may handle mapping the bill amounts and dates to their correct locations. In an example implementation, the stored procedure may provide table lookups to map the detail line items to their correct internal item identifier as well as their purpose on the overall bill (late fee, adjustment, payment, etc.). In certain example implementations, the stored procedure also can perform custom audits, such as logging items on the invoice that do not exist yet in a database and/or logging accounts/service locations that are previously unknown.

Certain embodiment may test the stored procedure and verify that the data was correctly transferred from the raw tables to the bill import data tables. Certain embodiments may create a batch framework task to invoke a stored procedure task base code and set its stored procedure call to the created procedure.

The complexity of the manipulation stage may vary based on differences between the raw data model and the bill import data model. Where possible, and according to certain example implementation, the raw model may be kept in line to mirror the bill import data model. In certain example implementations, the parser may be the most complex Stage for development so often it is more efficient to cover any additional complexity within the manipulation stage since it may be easier to maintain.

According to certain example embodiments, the following processing methodology may be utilized at this stage. It should be recognized that while there are variations, this listing may be representative of a common sequence of events. In certain example implementations, a batch framework job may be created containing this stage (task). While it is possible to run the batch framework job, this stage may utilize a job that includes the invoice parser stage before it.

In accordance with an example implementation, the batch framework job may provide the task with the parameters that will be used to process the stage. This stage may utilize a canned SQL stored procedure task, thus the database name and the name of the stored procedure to execute may be passed. In certain example implementations, the procedure called by the task can be either a wrapper stored procedure (that in turn determines what other procedure to call based on provided parameters), or it could call the manipulation stored procedure directly. In addition, to the aforementioned parameters, any parameters exposed by the stored procedure can also be passed by the job to the task.

In accordance with an example implementation, an action within the manipulation stored procedure may be to query the database to determine what invoices need to be manipulated. For example, this procedure may look in the invoice list table to see which ones have not yet been flagged as being manipulated. If there are none, this stage may end. If there are invoices to process, they may be done all at once so there is no looping like in the other stages. Certain example implementations of the disclosed technology may update the invoice list to reflect that the invoices have been manipulated and are now available for the bill data database to import.

Since the manipulation is so unique to each vendor and vendor bill format, there are too many variations to list here. However, one goal of this stage is to transfer the data from the raw tables to the bill import data tables so that the data is well structured and conforms to a unique standardized bill data import model, which may include all the information needed so it can be easily imported by a bill data database.

### Bill Database Overview

According to an example implementation of the disclosed technology, the bill database may handle various bill complexities. For example, in one implementation, a single bill may be processed with just one line item charge. In another example implementation, bills as complex as summary bills containing multiple accounts across multiple services with dissimilar quantities and units of measure may be handled. The bill database design, according to an example implementation of the disclosed technology, is simple enough to make research and reporting easy while at the same time allowing for robust data collection at almost all levels of detail.

According to an example implementation of the disclosed technology, bills or invoices may be entered into the bill database by one of two means: electronically or manually. For the purpose of this document, only the electronic method will be discussed. However, as will be mentioned in the next section, sometimes the two methods cross paths when electronically imported bills have audit issues that must be resolved manually.

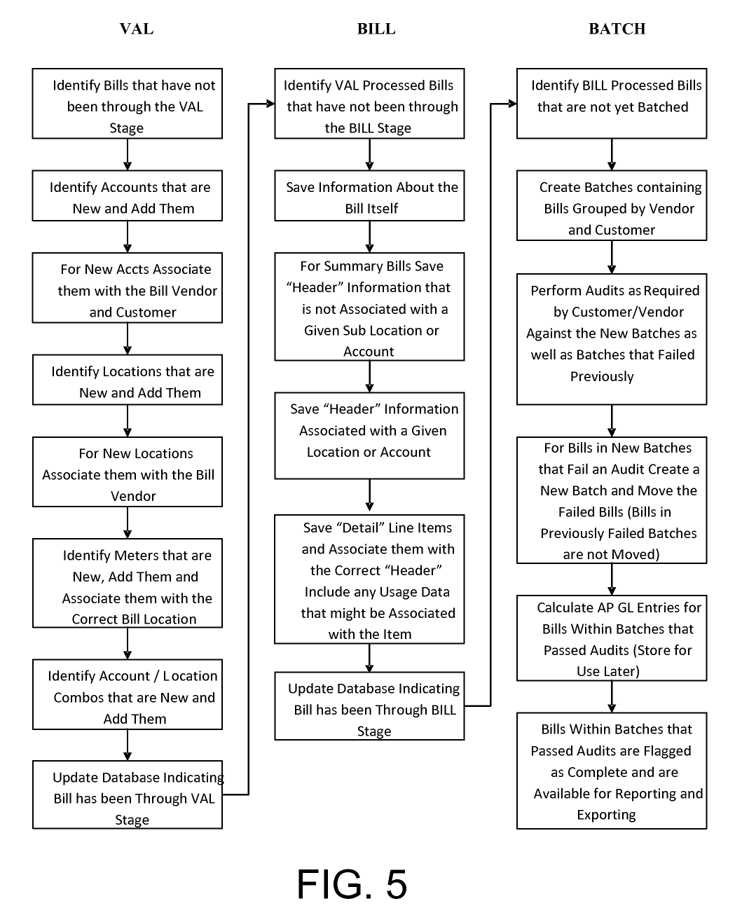

FIG. 5 is an example flow diagram of a standard bill import cycle with the various stages and associated steps. Certain example embodiments of the disclosed technology may utilize each stage and step, while other embodiments may omit certain steps as needed.

### Data Import Overview

The data import process brings the data from the billing data import database through distinct stages (VAL, BILL, and BATCH). Unlike the bill data collection process, example embodiments of these stages may all be done within one stored procedure, for example, which may be scheduled for execution through the batch framework as one task using the SQL stored procedure task. According to an example implementation of the disclosed technology, a bill may go through the stages in sequence and may move on to the next stage after completing the prior stage. At the time the procedure is executed, each stage may process all bills not yet processed absent any additional filtering.

In accordance with an example implementation, several parameters to the procedure allow for further refinement as to what bills will be processed. For example, a few of the main parameters may include vendor, customer, and bill format. The parameters may include the specific stage that is desired to be run, although this may only apply to the first two stages.

In one example implementation, the data import process may be run as a standalone job. In another example implementation, the data import process may be included as a stage (task) within the different bill data collection or bill importer processes discussed above. For example, this task may come after the manipulation stage or the audit stage (if one was included). This example embodiment may allow for a timelier turnaround on the bills brought in electronically.

In accordance with an example implementation, the import process may utilize the billing data import database, some legacy imports may require custom codes for each vendor bill format to be written within the import procedure.

### Stage 1—VAL (Vendor, Account and Location Relationships)

As shown in FIG. 5, the VAL (Vendor, Account, and Location Relationship) stage may check if the accounts, service locations and/or meters listed on the invoice exist and if not it attempts to add them. In certain example implementations, this stage may also check one or more relationships necessary, for example, between (1) the vendors and the accounts, (2) the customer and the accounts, (3) the vendors and the locations and (4) the accounts and locations. For those relationships that do not exist, they may be created. In certain example implementations, this stage may also roll child accounts under a parent in the case of summary bills and for those locations within a common market area. In certain example implementations, it will do lookups against the common market database list of locations to make sure the location information that is standard to all members of that common market.

### Stage 2—BILL (Bill Data Import)

In accordance with an example implementation, and for bills that have already been through Stage 1, this stage may attempt to import the actual bill data (totals, dates, line items, quantities, etc.), for example, using a billing data import database. In certain example implementations, the majority of the work may be done via an item external links table, which links the bill line items from the billing data import table with the items in the database. All the other work of determining what charges go where, what items have quantities, and which don't may be done in the bill data collection process.

### Stage 3—Batching

After Stage 2, the bill data may be been completely loaded into the bill database, albeit unaudited. Example embodiments of this final stage may take all the bills that just successfully completed Stage 2 (above) and puts them in to batches. Batches, for example, can be comprised of any grouping of bills. In an example implementation, the standard grouping may be by vendor and customer. According to an example implementation of the disclosed technology, these batches may then be run though a customizable audit process. Bills that fail audits, for example, may be removed from the batch that they were originally placed in and moved to a new problem bills batch where they can be further researched. Bills that pass, for example, may remain in their batch and that batch may be flagged as “posted” to signify that bill entry has been completed and the bills are available for reporting and exports.

In accordance with an example implementation of the disclosed technology, bill batches that successfully pass the audit may be further processed to a group. According to an example implementation, correct general ledger (GL) accounts (with associated GL numbers, for example) for each bill and/or each charge in the batch may be calculated and assigned. In one embodiment, this may be done by using the item grouping module (which is discussed below). For the purpose of the assigning of GL accounts, and according to an example implementation, the item grouping module may allow for different levels of grouping that can act on their own or combined together. In certain example implementations, the levels of groupings may include one or more of: (1) normalizing like items regardless of vendor naming conventions into “Master Items” (for example taxes, late fees, new account fee, etc.) that apply to all customers; (2) grouping Master Items or individual items into more specific item groupings required by the client for the purpose of the GL account assignment (examples can include electric deposits, electric normal charges, electric penalties, etc.); and (3) further refinement to the item groups such that the item groups may be split depending on additional criteria that might be needed for GL account assignment (examples include common accounts, vacant accounts, etc.). In an example embodiment, the item grouping module may perform one or more of: creating the groups, assigning the groups an identifier that represents the group as well as the how it was built, normalizing consumption, and/or calculating the total charge for the group. In instances where the item grouping module is used to assign GL accounts, the item grouping module may perform additional steps. For example, the item grouping module may perform a database lookup using an identifier that represents the grouping to find what GL account has been assigned to it. In an example implementation, if the individual identifier is not found, the module may search back up through a hierarchical structure from which that individual grouping was generated until it finds a record associated with the GL account.

According to an example implementation of the disclosed technology, the bills that fail the audit and that are grouped in the problem bill batches may remain in a “pending” status that may require human intervention before they can be “posted”. Certain example implementations of the batch management and bill entry interface may provide the tools for manually correcting any problems found.

### Data Export Overview

In certain example implementations, the data export may be a robust system for grouping and formatting data to meet the needs of any external consumer. In certain example implementations, the export module may be made up of several parts: (1) an export control table to represents a unique export and define the purpose and destination; (2) an export members table to control what vendor/customers invoices should be included; (3) item groups table to control what items should or should not be included in the export; an exports table to track individual occurrences of the export control; and (4) an export history table to keep a record of each attempt to disseminate the export and a copy of the data being exported if it is in a text based format (XML, CSV, Text-delimited, etc.)

In accordance with an example implementation, the Export module may incorporate several other modules to complete the process. For example, additional models may include, but are not limited to: (a) a batch module for tracking the invoices that are grouped into each export; (b) an item grouping module to control what items should be included or excluded from the export; and (c) an auditing module to perform any additional audits that might be need.

According to an example implementation of the disclosed technology, the actual execution of an export control may consists of two parts. The first part being a stored procedure used to initiate a new export under the export control, gather the data as determined in part by the item grouping module and format the data as required. The second part being a wrapper batch framework task that may call the aforementioned stored procedure, perform any additional data formatting, put the data into the correct file type and finally attempt to transmit to the destination.

According to an example implementation of the disclosed technology, any invoices that have been loaded into the bill database, passed their audits, and are flagged as completed can be exported. A given invoice, for example, can be included as part of multiple export controls but only once per control export. This may be controlled via the batch module where, according to an example implementation, each export control may link to a matching batch control that guarantees an invoice will only be used once.

In accordance with an example implementation, a special export control type (AP Export) may be included, and for a given customer there may be only be one export control of this type setup. This specialized type, according to an example implementation, denotes the export control that may be used when transmitting data to the primary accounting system. That is not to say bills cannot be exported to other accounting systems, but for the purposes of internal tracking and other budgetary and reporting purposes this special export type may be used.

### AP Export Overview

In accordance with an example implementation, the AP Export is a specialized export control type that may be processed just like any other data export with two exceptions. First, the stored procedure may not need to use the item grouping module because this may have already been performed when the AP general ledger entries are created during the data import process. The only other exception being invoices within an AP Export batch that have been successfully exported. In this case, they may be locked at the end of the export process. This lock means the previously calculated AP general ledger entries can no longer be modified so as to keep a true record of what was uploaded for accounting, budgeting and reporting purposes.

### AP Export Cycle

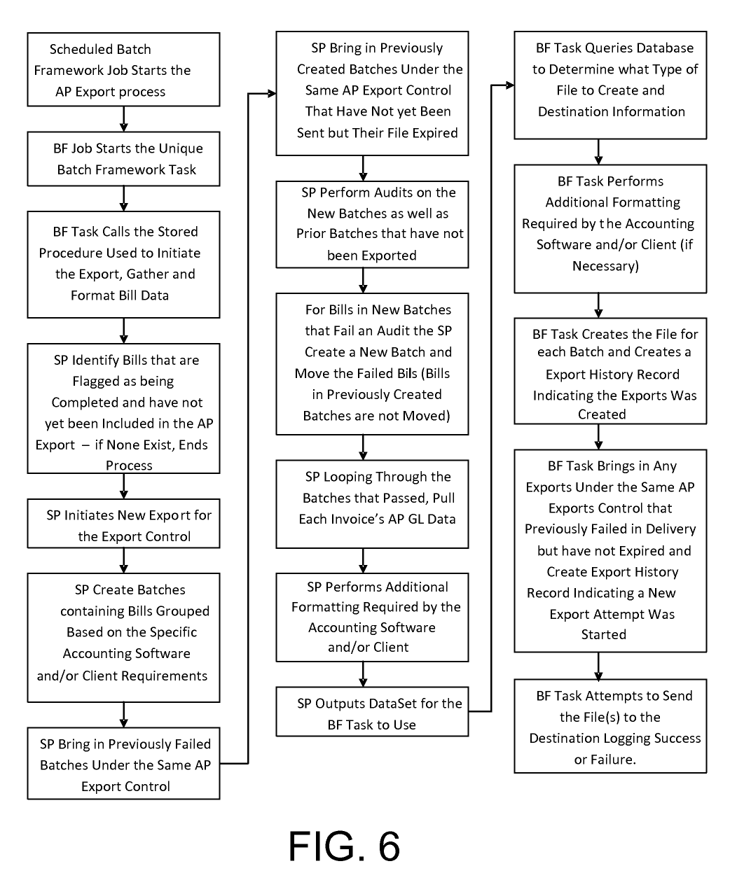

FIG. 6 shows an example flow diagram of a standard AP Export cycle with the various stages and associated steps, according to an example implementation of the disclosed technology. Certain example embodiments of the disclosed technology may utilize each stage and step, while other embodiments may omit certain steps as needed. This diagram assumes that the invoices have already been through the data import process and had their AP general ledger entries calculated.

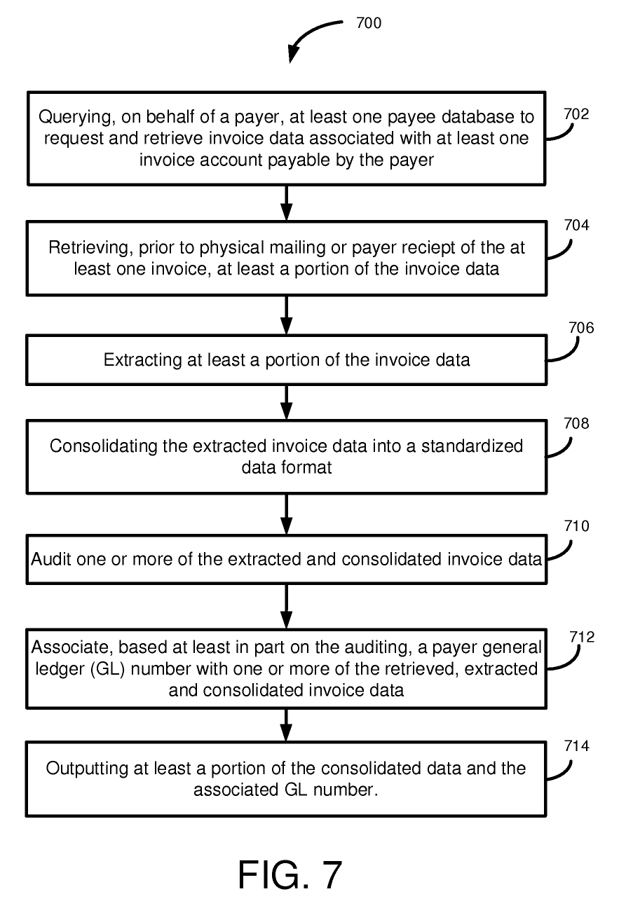

FIG. 7 is a flow diagram of a method 700 according to an example implementation. The method 700 begins in block 702 and includes querying, on behalf of a payer, at least one payee database to request and retrieve invoice data associated with at least one invoice account payable by the payer. In block 704, the method 700 includes retrieving, prior to physical mailing or payer receipt of the at least one invoice, at least a portion of the invoice data. In block 706, the method 700 includes extracting at least a portion of the invoice data. In block 708, the method 700 includes consolidating the extracted invoice data into a standardized data format. In block 710, the method 700 includes auditing one or more of the extracted and consolidated invoice data. In block 712, the method 700 includes associating, based at least in part on the auditing, a payer general ledger (GL) number with one or more of the retrieved, extracted and consolidated invoice data. In block 714, the method 700 includes and outputting at least a portion of the consolidated data and the associated GL number.

According to example implementations of the disclosed technology, the querying may include one or more of an automated login to a web portal; an automated navigation to an invoice; an automated navigation to invoice list; and/or a submission of a request for access to the invoice data.

In certain example implementations of the disclosed technology, the retrieving can include one or more of electronically extracting from the payee database, one or more invoices associated with the query request; and/or storing the extracted one or more invoices.

In accordance with an example implementation, extracting the invoice data can include one or more of evaluating a source file associated with the payee database; determining what data should be retrieved; extracting individual data elements specific to the payee invoice format; and/or storing the extracted data elements.

In an example implementation, auditing the retrieved invoice data may include, as applicable, one or more of determining whether the invoice is a duplicate; verifying a total invoice amount based on line item amounts; checking prior balances against invoice history; verifying payer account numbers; verifying service locations associated with the invoice; verifying dates associated with the invoice; and/or determining a payer general ledger (GL) number associated with the invoice.

In accordance with example implementations, consolidating the retrieved invoice data into a standardized data format can include one or more of determining whether vendor, account, and location (VAL) data exists, the VAL data comprising one or more of: account number, service location, and meter identification (ID); generating, as applicable, missing VAL data; associating, as applicable, service location with their regional market identifiers; normalizing, as applicable, service location addresses to a subset of USPS standards; associating, as applicable, child accounts with parent accounts; and/or storing line items of the retrieved invoice data to a standardized data structure.

In accordance with an example implementation, outputting can include electronically uploading at least a portion of the consolidated data and the associated GL number to an accounting module associated with the payer. In an example implementation, retrieving at least a portion of the invoice data can include processing one or more images to extract information.

According to example implementations, certain technical effects can be provided, such as creating certain systems and methods that automatically retrieve, extract, consolidate, and audit electronic bills.

Throughout the specification and claims, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Various techniques described herein may be used to detect interactions with a computing device. The various aspects described herein are presented as methods, devices (or apparatus), systems, and articles of manufacture that may include a number of components, elements, members, modules, nodes, peripherals, or the like. Further, these methods, devices, systems, and articles of manufacture may include or not include additional components, elements, members, modules, nodes, peripherals, or the like.

According to one example implementation, the term computing device, as used herein, may be a CPU, or conceptualized as a CPU (for example, the CPU 302 of FIG. 3). In certain example implementations, the computing device (CPU) may be coupled, connected, and/or in communication with one or more peripheral devices, such as display, navigation system, stereo, entertainment center, Wi-Fi access point, etc. In another example implementation, the term computing device or mobile computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In an example embodiment, the mobile computing device may output content to its local display and/or speaker(s). In another example implementation, the mobile computing device may output content to an external display device (e.g., over Wi-Fi) such as a TV or an external computing system.

Furthermore, the various aspects described herein may be implemented using standard programming or engineering techniques to produce software, firmware, hardware, or any combination thereof to control a computing device to implement the disclosed subject matter. The term “article of manufacture” as used herein is intended to encompass a computer program accessible from any computing device, carrier, or media. For example, a computer-readable medium may include a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In example implementations of the disclosed technology, the computing device 300 may include any number of hardware and/or software applications that are executed to facilitate any of the operations. In example implementations, one or more I/O interfaces may facilitate communication between the computing device 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device 300. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

As desired, implementations of the disclosed technology may include the computing device 300 with more or less of the components illustrated in FIG. 2 and/or FIG. 3.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
querying, on behalf of a payer, at least one payee database to request and retrieve invoice image associated with at least one invoice account payable by the payer;
retrieving by pulling, prior to an e-bill notification of the at least one invoice, at least a portion of the invoice image;
electronically extracting at least a portion of invoice data from the invoice image;
consolidating the extracted invoice data into a standardized data format;
auditing one or more of the extracted and consolidated invoice data;
associating, based at least in part on the auditing, a payer general ledger (GL) number with one or more of the retrieved, extracted and consolidated invoice data; and
outputting at least a portion of the consolidated data and the associated GL number.

2. The computer implemented method of claim 1, wherein the querying comprises one or more of:
an automated login to a web portal;
an automated navigation to an invoice;
an automated navigation to invoice list; and
a submission of a request for access to the invoice data.

3. The computer-implemented method of claim 1, wherein the retrieving comprises one or more of:
electronically extracting from the payee database, one or more invoices associated with the query request; and
storing the extracted one or more invoices.

4. The computer-implemented method of claim 1, wherein the extracting the invoice data comprises one or more of:
evaluating a source file associated with the payee database;
determining what data should be retrieved;
extracting individual data elements specific to the payee invoice format; and
storing the extracted data elements.

5. The computer-implemented method of claim 1, wherein auditing the retrieved invoice data comprises, as applicable, one or more of:
determining whether the invoice is a duplicate;
verifying a total invoice amount based on line item amounts;
checking prior balances against invoice history;
verifying payer account numbers;
verifying service locations associated with the invoice;
verifying dates associated with the invoice; and
determining a payer general ledger (GL) number associated with the invoice.

6. The computer-implemented method of claim 1, wherein the consolidating the retrieved invoice data into a standardized data format comprises one or more of:
determining whether vendor, account, and location (VAL) data exists, the VAL data comprising one or more of: account number, service location, and meter identification (ID);
generating, as applicable, missing VAL data;
associating, as applicable, service location with their regional market identifiers;
normalizing, as applicable, service location addresses to a subset of USPS standards;
associating, as applicable, child accounts with parent accounts; and
storing line items of the retrieved invoice data to a standardized data structure.

7. The computer-implemented method of claim 1, wherein the outputting comprises electronically uploading at least a portion of the consolidated data and the associated GL number to an accounting module associated with the payer.

8. The computer-implemented method of claim 1, wherein retrieving at least a portion of the invoice data comprises processing one or more images to extract information.

9. A system comprising:
at least one memory for storing data and computer-executable instructions; and at least one processor configured to access the at least one memory and further configured to execute the computer-executable instructions to:
query, on behalf of a payer, at least one payee database to request and retrieve an invoice image associated with at least one invoice account payable by the payer;
retrieve by pulling, prior to an e-bill notification of the at least one invoice, at least a portion of the invoice image;
electronically extract at least a portion of invoice data from the invoice image;
consolidate the extracted invoice data into a standardized data format;
audit one or more of the extracted and consolidated invoice data;
associate, based at least in part on the auditing, a payer general ledger (GL) number with one or more of the retrieved, extracted and consolidated invoice data; and
output at least a portion of the consolidated data and the associated GL number.

10. The system of claim 9, wherein the at least one processor is further configured to execute the computer-executable instructions to perform, as applicable, one or more of:
an automated login to a web portal;
an automated navigation to an invoice;
an automated navigation to invoice list; and
and submission of a request for access to the invoice data.

11. The system of claim 9, wherein the at least one processor is further configured to execute the computer-executable instructions to perform, as applicable, one or more of:
electronically extract from the payee database, one or more invoices associated with the query request; and
store the extracted one or more invoices.

12. The system of claim 9, wherein the at least one processor is further configured to execute the computer-executable instructions to perform, as applicable, one or more of:
evaluate a source file associated with the payee database;
determine what data should be retrieved;
extract individual data elements specific to the payee invoice format; and
store the extracted data elements.

13. The system of claim 9, wherein the at least one processor is further configured to execute the computer-executable instructions to perform, as applicable, one or more of:
determine whether the invoice is a duplicate;
verify total invoice amount based on line item amounts;
check prior balances against invoice history;
verify payer account numbers;
verify service locations associated with the invoice;
verify dates associated with the invoice; and
determine a payer general ledger (GL) number associated with the invoice.

14. The system of claim 9, wherein the at least one processor is further configured to execute the computer-executable instructions to perform, as applicable, one or more of:
determine whether vendor, account, and location (VAL) data exists, the VAL data comprising one or more of: account number, service location, and meter identification (ID);
generate, as applicable, missing VAL data;
associate, as applicable, service location with their regional market identifiers;
normalize, as applicable, service location addresses to a subset of USPS standards;
associate, as applicable, child accounts with parent accounts; and
store line items of the retrieved invoice data to a standardized data structure.

15. The system of claim 9, wherein the at least one processor is further configured to execute the computer-executable instructions to electronically upload at least a portion of the consolidated data and the associated GL number to an accounting module associated with the payer.

16. The system of claim 9, wherein the at least one processor is further configured to execute the computer-executable instructions retrieve at least a portion of the invoice data and process one or more images to extract information.

17. A non-transient computer-readable medium storing instructions, that when executed by a user device having one or more processors, cause the one or more processors to perform a method comprising:
querying, on behalf of a payer, at least one payee database to request and retrieve an invoice image associated with at least one invoice account payable by the payer;
retrieving by pulling, prior to an e-bill notification of the at least one invoice, at least a portion of the invoice image;
electronically extracting at least a portion of invoice data from the invoice image;
consolidating the extracted invoice data into a standardized data format;
auditing one or more of the extracted and consolidated invoice data;
associating, based at least in part on the auditing, a payer general ledger (GL) number with one or more of the retrieved, extracted and consolidated invoice data; and
outputting at least a portion of the consolidated data and the associated GL number.

18. The non-transient computer-readable medium of claim 17, wherein the querying comprises one or more of:
an automated login to a web portal;
an automated navigation to an invoice;
an automated navigation to invoice list; and
a submission of a request for access to the invoice data.

19. The non-transient computer-readable medium of claim 17, wherein the retrieving comprises one or more of:
electronically extracting from the payee database, one or more invoices associated with the query request; and
storing the extracted one or more invoices.

20. The non-transient computer-readable medium of claim 17, wherein the extracting the invoice data comprises one or more of:
evaluating a source file associated with the payee database;
determining what data should be retrieved;
extracting individual data elements specific to the payee invoice format; and
storing the extracted data elements.

21. The non-transient computer-readable medium of claim 17, wherein auditing the retrieved invoice data comprises, as applicable, one or more of:
determining whether the invoice is a duplicate;
verifying a total invoice amount based on line item amounts;
checking prior balances against invoice history;
verifying payer account numbers;
verifying service locations associated with the invoice;
verifying dates associated with the invoice; and
determining a payer general ledger (GL) number associated with the invoice.

22. The non-transient computer-readable medium of claim 17, wherein the consolidating the retrieved invoice data into a standardized data format comprises one or more of:
determining whether vendor, account, and location (VAL) data exists, the VAL data comprising one or more of: account number, service location, and meter identification (ID);
generating, as applicable, missing VAL data;
associating, as applicable, service location with their regional market identifiers;
normalizing, as applicable, service location addresses to a subset of USPS standards;
associating, as applicable, child accounts with parent accounts; and
storing line items of the retrieved invoice data to a standardized data structure.

23. The non-transient computer-readable medium of claim 17, wherein the outputting comprises electronically uploading at least a portion of the consolidated data and the associated GL number to an accounting module associated with the payer.

24. The non-transient computer-readable medium of claim 17, wherein retrieving at least a portion of the invoice data comprises processing one or more images to extract information.
